(19) United States
(12) Patent Application Publication
(10) Pub. No.: US 2003/0167926 A1
(43) Pub. Date: Sep. 11, 2003

(54) Portable air cleaning, heating, and cooling apparatus

(76) Inventor: Dennis Albert Littrell, Asheville, NC (US)

Correspondence Address: Dennis A. Littrell, 11 Green Oak Rd., Asheville, NC, 28804, US

(21) Appl. No.: 10/092,236

(22) Filed: Mar. 6, 2002

(51) Int. Cl. B01D 47/00

(52) U.S. Cl. 96/316; 96/322

(57) ABSTRACT

An air cleaning system comprising the means to displace air, contact the displaced air with a liquid, exhaust the cleaned air, and discharge the used liquid; and the means to clean the used liquid, heat or cool the liquid, impart a charge to the liquid, and displace and direct the liquid whereby indoor air is cleaned and indoor air temperature is controlled.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

Currently, indoor air cleaning systems primarily use filters to directly clean indoor air and all air filtering systems suffer from a number of disadvantages. They do not maximize the proportion of air in a room that is cleaned because their low-height designs do not optimally facilitate the circulation of the air in the room. They operate at low air flow rates and do not optimize cleaning performance with respect to the number of times that the air in the room is exchanged over a given amount of time. They lack scalability because an air cleaning system using a filter to directly clean air is limited in design to the cross-sectional area of the filter and to the maximum flow rate of air that the filter can handle. Further, indoor air cleaning systems do not provide the means to heat or cool the air that is being cleaned. Finally, expensive filters must be replaced frequently because the amount of air being cleaned decreases over time as impurities are collected by the filter.

### BRIEF SUMMARY OF THE INVENTION

My invention removes impurities from indoor air by washing the air with water. The used water is subsequently cleaned, heated or cooled, and reused. Several objects and advantages of my air cleaning system are to maximize the proportion of air in a room that is cleaned; to operate at a high capacity; to provide greater scalability to an air cleaning system; to provide the means to heat or cool the air that is being cleaned; and to continuously operate at the optimum capacity. Further objects and advantages are to reduce the costs of operating and maintaining an air cleaning system and to reduce indoor heating and cooling costs.

### REFERENCE NUMERALS IN DRAWINGS

| | | | |
|---|---|---|---|
| 2 | vent | 4 | air washing mechanism |
| 6 | media container | 8 | reservoir |
| 10 | air slots in vent | 12 | hole in side near bottom |
| | | | of vent |
| 14 | notch with thread | 16 | notch with groove |
| 18 | stem | 20 | blade |
| 22 | conduit | 24 | perforations in hollow |
| | | | portion of blade |
| 26 | grates in solid portion of blade | 28 | perforations in mechanism |
| 30 | slot in annulus | 32 | annulus |
| 34 | hole in mechanism | 36 | water line |
| 38 | perforations in bottom of container | 40 | hole in reservoir |
| 42 | hole in reservoir | 44 | valve |
| 46 | removable access panel | 48 | slots in reservoir |
| 50 | fill line in reservoir | 52 | grooves along main axis |
| | | | of surface |

### BRIEF DESCRIPTION OF THE SEVERAL VIEWS OF THE DRAWINGS

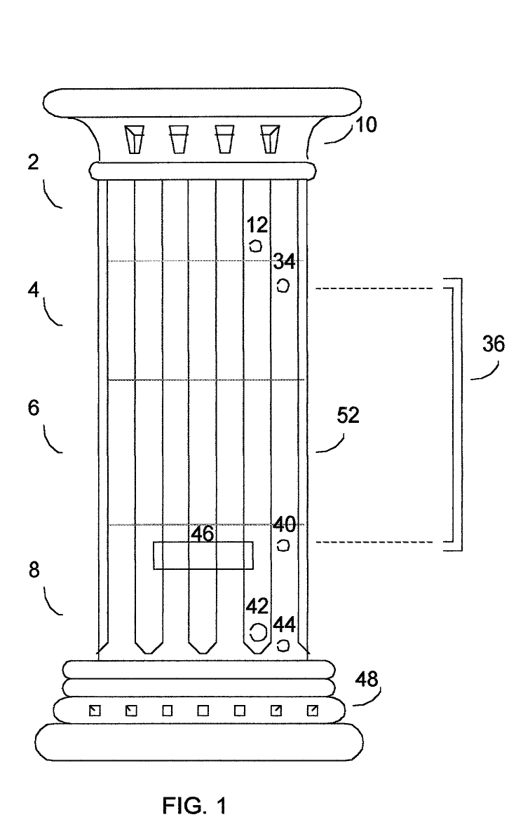

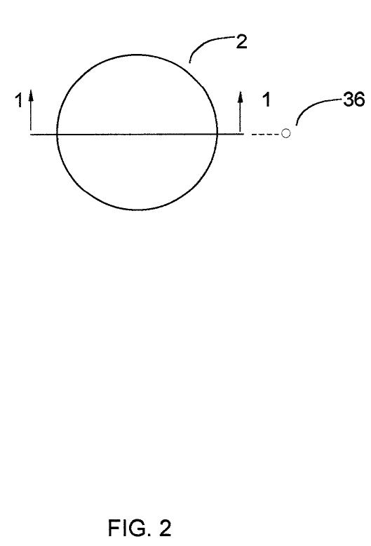

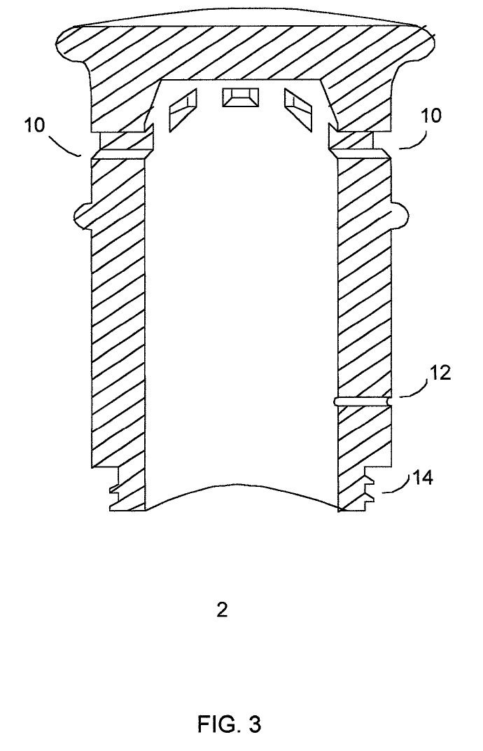

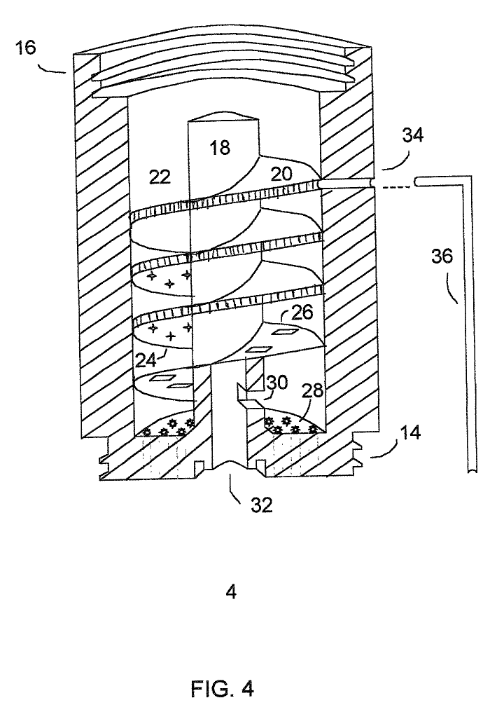

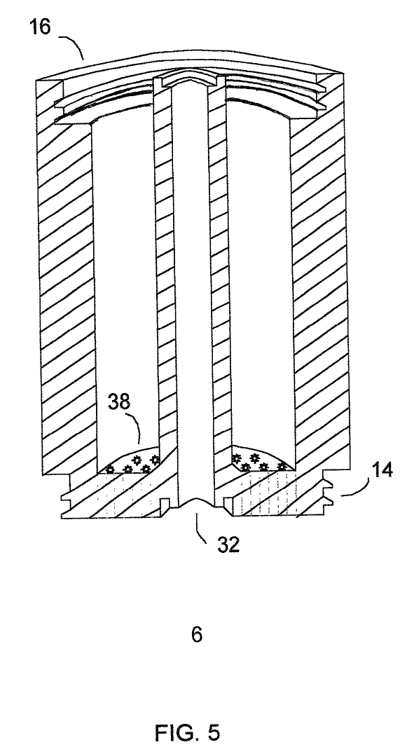

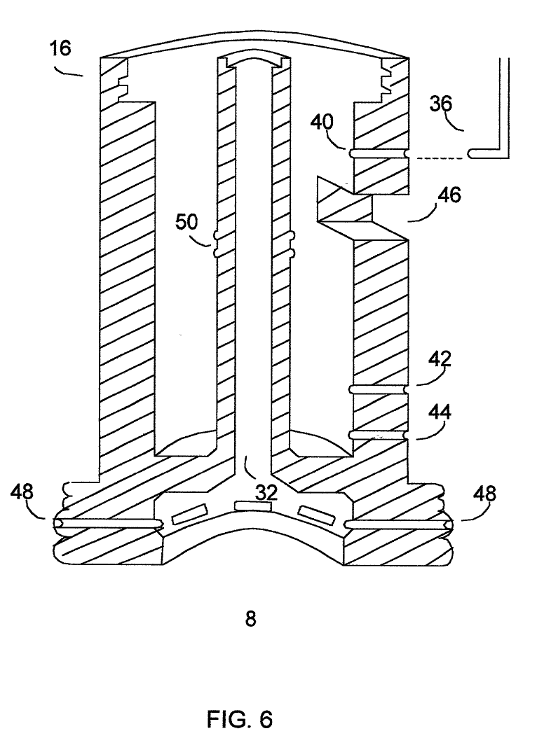

The present embodiment of my invention is presented in FIGS. 1 through 6. FIG. 1 shows the rear view of the elements of the air washing system interconnected. The front and side views of the system are unremarkable. FIG. 2 shows the top view of the air washing system and denotes the view of the cross sections presented in FIGS. 3 through 6. FIG. 3 shows the vent 2; FIG. 4 shows the air washing mechanism 4; FIG. 5 shows the media container 6; and FIG. 6 shows the reservoir 8.

### DETAILED DESCRIPTION OF THE INVENTION

As shown in FIG. 1 the elements are generally cylindrical. To improve visual appeal and to promote assembly, the exterior surfaces of the elements contain grooves 52 along the main axis of the assemblage. An element is connected to another element by threading a contiguous thread on a notch in the element through a contiguous groove in a notch in the other element.

An air vent 2 (FIG. 3) distributes cleaned air upward and outward throughout 360 degrees to promote circulation of air within a room. The top of the vent 2 is solid and there are slots 10 in the vent 2. The power cord for a fan (not shown) passes through a hole 12. The bottom of the vent 2 is open and conforms to the uniform means of connecting elements of the system 14 and connects onto an air washing mechanism 4.

The air washing mechanism 4 (FIG. 4) contains a solid stem 18 and a contiguous blade 20 wherein the revolutions of the blade 20 about the stem 18 form a conduit 22. Air enters the conduit 22 through a slot 30 in a cocentric annulus 32 in the stem 18. Cleaned air exits the mechanism 4 through the conduit 22 to the vent 2. One revolution of the blade 20 is hollow and both the top and the bottom of the blade 20 are solid so that water is contained. Water enters the blade 20 through a hole 34 coupled to a quick-connect fitting. The quick-connect fitting is attached to a quick-connect fitting on a water line 36. Two revolutions of the blade 20 are hollow and the top of the blade 20 is solid and the bottom of the blade 20 is perforated 24 so that water flows from the mechanism 4 by the forces of gravity and the static pressure head of the water. One revolution of the blade 20 is solid and grated 26 to allow the used water to trickle downward. And one revolution of the blade 20 terminates contiguous with the mechanism 4 and has perforations 28 so that water is discharged. The mechanism 4 proscribes to the uniform means of connecting elements of the system 14 and 16 and connects onto a container 6.

The container 6 (FIG. 5) contains one or more media through which water from the mechanism 4 flows and wherein impurities removed from the air are removed from the water. Air passes through the container 6 through a cocentric annulus 32 to the mechanism 4. The top of the container 6 is open and the bottom of the container 6 is perforated 38 so that the cleaned water trickles from the container 6. The container 6 conforms to the uniform means of connecting elements of the system 14 and 16 and connects onto a reservoir 8.

The reservoir 8 (FIG. 6) conforms to the uniform means of connecting elements of the system 16. The top of the reservoir 8 is open and the bottom of the reservoir 8 is solid to contain water. A pump inside the reservoir (not shown) pumps water through a line in the reservoir 8 through a hole 40 in the reservoir 8. The hole 40 and the line are coupled by a washer mechanism (not shown) to prevent leakage and the portion of the line protruding from the hole 40 in the reservoir 8 is the water line 36 to the mechanism 4. A quick-connect fitting is attached to the end of the water line 36. A water chiller (not shown) and a water heater (not shown) maintain the temperature of the water in the reservoir 8 within at a set temperature range so that the air cleaning system is able to continuously warm or cool the air that it cleans. The power cords exit the reservoir 8 through a hole 42 in the reservoir 8 and the cords and the hole 42 are coupled by a washer mechanism (not shown) to prevent leakage. A drain valve 44 can be used to manually withdraw water from the reservoir 8. A removable access panel 46 provides access to the contents of the reservoir 8 without disconnecting the assembly. Slots 48 in the reservoir 8 allow air to be withdrawn from the room throughout 360 degrees. Air passes through the reservoir through a cocentric annulus 32 to the container 6. Cocentric fill lines 50 about the annulus 32 denote the maximum and minimum water levels for the reservoir 8. Portability is promoted by mounting wheels or coasters (not shown) along the bottom circumference of the reservoir 8.

Other embodiments of my invention will force the air through the system whereas the presented imbodiment pulls air through the system. Other embodiments of my invention will be designed to automatically maintain the appropriate water level in the reservoir and to impart a slight electrical charge to the water.

The manner of setting up and operating the system follows. First, place the reservoir 8 at the desired location in the room. Place a predetermined amount of water into the reservoir 8. Insert the access panel 46 into the reservoir 8. Place predetermined amounts of pollutant removing media into the container 6. Place notch 14 of the container 6 into notch 16 of the reservoir 8 and thread the container 6 onto the reservoir 8. Place notch 14 of the air washing mechanism 4 into notch 16 of the container 6 and thread the mechanism 4 onto the container 6. Place notch 14 of the vent 2 into notch 16 of the mechanism 4 and thread the vent 2 onto the mechanism 4. Attach the water line 36 to the quick connect fitting 34 of the mechanism 4. Connect the power cords for the pump, fan, chiller, and heater to a power source. Turn on the pump. Turn on the fan. Set the theromstat to the desired temperature.

The manner of regularly maintaining the system follows. Turn off the pump, fan, chiller, and heater. Allow the water to trickle into the reservoir 8. Remove and clean the vent 2. Disconnect the water line 36 from the mechanism 4. Remove and clean the mechanism 4. Remove the container 6, discard the used media, and add new media to the container 6. Place the water line 36 into a drain, turn on the pump, and pump most of the water in the reservoir 8 into the drain. Turn off the pump. Discard the remaining water in the reservoir 8 using the manual valve 44. Add fresh liquid to the reservoir 8. Reassemble and operate the system as previously described.

From the description above, a number of advantages of my air cleaning system over systems that directly filter air are evident. My invention can maximize the proportion of the air in a room that is cleaned; operate at a high capacity; provide greater scalability to an air cleaning system; provide a means to heat or cool the air that is being cleaned; and maintain a constant rate of clean air delivery. The system can reduce the cost of operating an air cleaning system by using less energy, increasing the time of operation between regular maintenance, and decreasing the cost of replacement media. The system can also reduce indoor air heating and cooling costs.

My invention can be scaled to meet either household or commercial needs such as delivering clean, disinfected air in a medical setting or delivering warm or cool air to rooms, homes, offices, and buildings. My invention can be used in many applications with the appropriate changes in the dimensions, materials of construction, pollutant removal media, and the liquid(s) used. Although the description above contains many specifications, these should not be construed as limiting the scope of my invention but as merely providing an illustration of the presently preferred embodiment of my invention.

1. An air cleaning system comprising the means to displace air, contact the displaced air with a liquid, exhaust the cleaned air, and discharge the used liquid; and the means to clean, displace, and direct a liquid whereby indoor air is cleaned.

2. The means to displace air, contact the displaced air with a liquid, exhaust the cleaned air, and discharge the used liquid of claim 1 wherein said means comprising a vent and an air washing mechanism.

3. The vent of claim 2 wherein said vent comprising the means to displace and distribute air.

4. The air washing mechanism of claim 2 wherein said mechanism comprising one or more surfaces wherein the surfaces form one or more conduits wherein the liquid and the displaced air are contained, mixed, and separated.

5. The means to clean, displace, and direct a liquid of claim 1 wherein said means comprising a container and a reservoir.

6. The container of claim 5 comprising the means to clean and discharge a liquid.

7. The reservoir of claim 5 comprising the means to displace and direct a liquid.

8. The reservoir of claim 5 further comprising the means to heat and cool a liquid.

9. The reservoir of claim 5 further comprising the means to impart a slight electrical charge to the liquid.

10. The reservoir of claim 5 further comprising a means of portability.
